(19) United States
(12) Patent Application Publication
(10) Pub. No.: US 2022/0122055 A1
(43) Pub. Date: Apr. 21, 2022

(54) SYSTEM AND METHOD FOR GENERATING A BANK CARD DISTANCING WARNING

(71) Applicant: Toshiba TEC Kabushiki Kaisha, Shinagawa-ku (JP)

(72) Inventors: Jeffrey WONG, Lake Forest, CA (US); Louis ORMOND, Irvine, CA (US)

(21) Appl. No.: 17/074,831

(22) Filed: Oct. 20, 2020

(51) Int. Cl. G06Q 20/32; H04W 4/80; G06F 3/01; H04W 76/14

(52) U.S. Cl. CPC G06Q 20/3278; G06Q 20/3224; H04W 76/14; G06F 3/016; H04W 4/80

(57) ABSTRACT

A system and method for verifying proximity of a financial card to a smartphone or tablet includes initiating a Bluetooth pairing between the smartphone or tablet to Bluetooth circuitry on the financial card. Once pairing is complete, the pairing is monitored to verify that the pairing remains active. When pairing is lost, a notification is generated on a user interface of the smartphone or tablet. Power is supplied to the financial card via radio frequency energy. A user can notify a financial institution associated with the financial card when pairing is lost when the user believes the card may be compromised. Such notification may be done via the smartphone or tablet responsive to user input.

### TECHNICAL FIELD

This application relates generally loss prevention for financial cards.

### BACKGROUND

Cash transactions are becoming increasingly rare. Purchases of goods or services are made frequently at a point-of-sale, such as at a checkout counter, with a bank card, such as a credit card or a debit card. A card can be mistakenly left at the terminal by a consumer. As used herein, financial cards includes cards such as credit cards or debit cards, suitably issued by a bank, credit agency, or other financial institution.

In particular situations, such as at locations such as restaurants, a server typically leaves a check at a table for review by a diner. Once approved, the diner typically gives their credit card to their server who takes it to a sales terminal to commence an electronic credit transaction. A credit receipt is returned to the diner's table for finalization and signing. The receipt and credit card are frequently returned to the diner in a jacket. Not infrequently, the diner may sign the check and close the jacket, but forget to retrieve their credit card, leaving the jacketed credit card on the table when they depart. The credit card may not be seeable within the jacket, and it may be some time before the server retrieves it. By the time the card is discovered, the diner may be far removed from the premises, and the restaurant may have no information which would allow them to contact the diner. The diner may not realize the card was left until the next time they reach for it to make a purchase. They may not recall where they left it, forcing them to cancel the card and suffer the inconvenience of ordering a replacement and monitoring for possible, unauthorized charges which they may need to dispute promptly with their credit agency. A restaurant may hold unclaimed credit cards for a period before destroying them or returning them to the issuing agency. There is an opportunity for thieves to steal an inadvertently left credit card and use it for unauthorized purchases. In certain situations, such as with travelers, the diner may be hundreds or thousands of miles away from the restaurant before they realize they left their card.

### BRIEF DESCRIPTION OF THE DRAWINGS

Various embodiments will become better understood with regard to the following description, appended claims and accompanying drawings wherein:

FIG. 1 is an example embodiment of a card proximity sensor system that operates between a portable data device, such as smartphone, and a financial or bank card;

FIG. 2 is an example embodiment of a Bluetooth proximity detection system;

FIG. 3 is an example embodiment of a system for maintaining a credit card in close proximity to smartphone;

FIG. 4 is a flowchart of an example embodiment of an application running on a portable data device that accomplishes monitoring of devices such as bank cards via Bluetooth pairing; and

FIG. 5 is an example embodiment of constituent interactions associated with distance monitoring via Bluetooth pairing.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In situations, such as with restaurants as noted above, a bank card may be taken by a server, who walks some distance to a terminal to run the card for a commercial transaction. In example embodiments described herein, a card may be fitted with a proximity sensor relative to a user's portable data device, such as a smartphone or tablet. Bank cards are formed in standardized dimensions to allow them to be carried in wallets. The standardized dimensions also allow cards to work with credit terminals. Their length and width must work with the terminals for insertion into a card reader slot for reading of an embedded chip. Their thickness must work with the reader slot, and also with a slide slot when the card's magnetic strip is swiped.

Credit card size is governed by the ISO/IEC 7810 standard, and is referred to as ID-1. The ID-1 format specifies dimensions of 85.60 mm (approximately 3.37 inches)×53.98 mm (approximately 2.12 inches), with a thickness of 0.76 mm ( 1/32 of an inch). Any tracking system used with a credit card must not cause an increase in card dimensions so as to render the card incompatible with card readers or swipe readers. In example embodiments herein, proximity detection is accomplished with circuitry that maintains ID-1 dimensions. In other example embodiments, circuitry is thicker than 0.76 mm, but such increased thickens is associated with a card area that does not engage a card swiper or a chip reader slot. Even with such an increased thickness area, thinner is advantageous to allow a card to be stored in a wallet or cardholder.

In example embodiments herein, a mobile application can notify the user when the credit card is out of range from Bluetooth pairing to prevent credit cards from being lost or stolen. This functions to prevent loss, theft or fraud and give a user peace of mind that their credit cards are not lost or stolen. With the use of Bluetooth pairing, with circuitry embedded in a bank card or via a sticker attached on a card that works with a Bluetooth enabled mobile device application that monitors a pairing connection between the card and the mobile device. The application can notifies the user when the connection is broken. This will alert the user that the credit card is out of range and that they should check to see if the credit card has been lost or stolen. The user can take the appropriate action to notify the credit card company that the card has been lost or stolen and prevent loss of money due to fraud, suitably via an agency notification initiated via the application.

Bluetooth is particularly advantageous over systems, such as near-field communication (NFC) or radio frequency identification RFID, due to its range. NFC range may be limited to centimeters. RFID range may extend for meters. In the restaurant example, a server may be well outside of either range to run a credit card. A system continuously monitoring a relative card position would trigger an alarm, warning or other notification during such an operation. Bluetooth range can be substantially longer. An alarm for card circuitry paired with a smartphone is suitably generated when pairing is broken due to distancing.

Bluetooth currently has versions 1 through 5. Bluetooth 1.x and 2.x are considered classic Bluetooth. Bluetooth 3 adds a high speed mode with uses Wi-Fi for a data connection, using Bluetooth for device discovery. Bluetooth 4.x and 5.x are referred to as Bluetooth Low Energy (BLE or BTLE). BTLE includes a system for advertising device presence. BTLE can have an outdoor range around 100 m (approximately 328 feet). Even with reduced range due to indoor obstructions, the range is sufficiently large that no alarm should be triggered while a server leaves to swipe a card. Conversely, the range is sufficiently small that an alarm can be generated while a user is still close enough to a card location to easily return to retrieve it.

NFC and RFID tags are passive devices. That is, they require no power source. Power is supplied to them via radio frequency energy emanating from powered readers. Conversely, Bluetooth requires active, powered circuitry. As noted above, it is critical that card thickness be maintained so as to be compatible with card readers and chip readers. Embedded circuitry or circuitry applied via a sticker must be powered, and the circuitry must include a power source, such as a battery. Batteries, even hearing aid size batteries, can render a card unusable. Credit cards are issued with expiration dates several years later, which could be much longer than the life of an embedded power cell. In embodiments herein, additional power for is obtained by radio frequency waves, employing available sources such as NFC or RFID waves. Additional power may be derived from Wi-Fi. Such power is captured via what may be referred to as a “rectenna.” By way of further example, Massachusetts institute of Technology (MIT) researchers developed a flexible and inexpensive two-dimensional semiconductor that eliminates need for a thick and inflexible rectifier A super thin and malleable material known as molybdenum disulfide (MoS2), one of the thinnest semiconductors in the world, functionally surpasses this limitation. While NFC and RFID waves may be distance limited, Wi-Fi is ubiquitous. As used herein, any suitable radio wave may be used to capture energy, alone or in combination with other suitable radio wave sources.

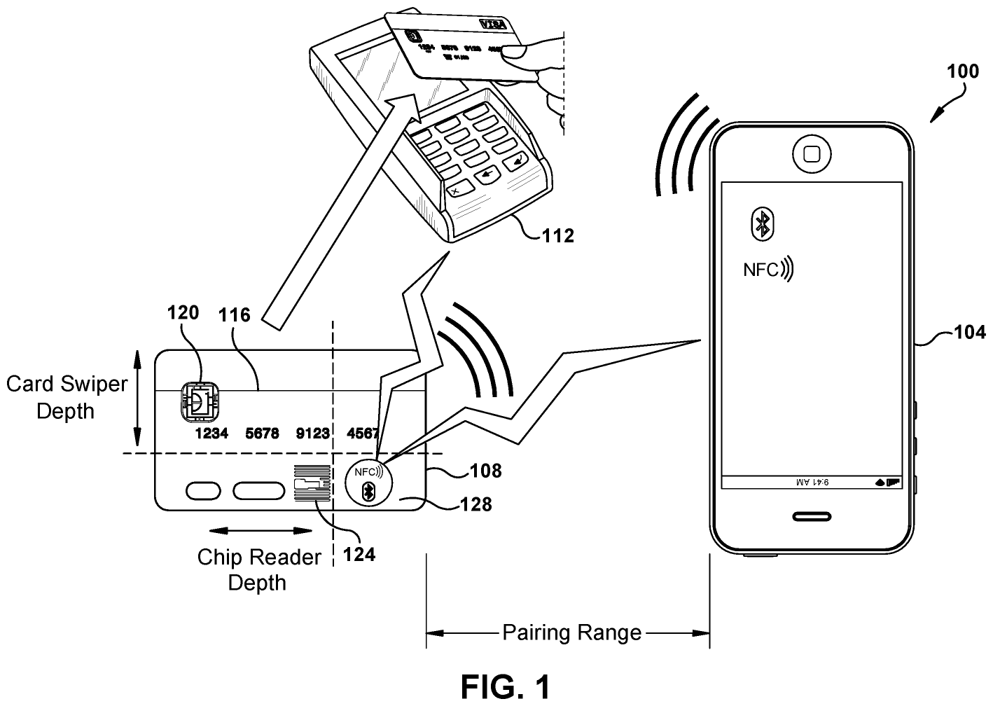

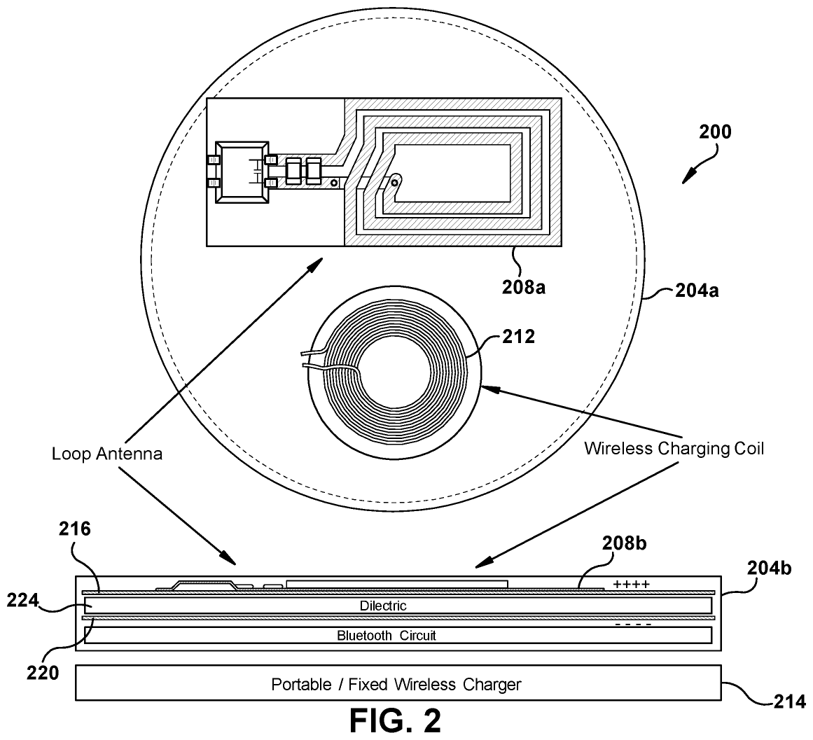

FIG. 1 is an example embodiment of a card proximity sensor system 100, such as with smartphone 104 and credit card 108, both of which are Bluetooth enabled. Credit card 108 is structured to interact with card reader 112 via a swipe of magnetic strip 116, reading of embedded chip 120 after card insertion, or via an RFID read of tag 124. Portable data devices, such as smartphone 104, frequently include NFC signal transmitters. Card 108 is also provided with antenna to receive NFC and/or RFID signals, for example in area 128 of card 108 and as described in further detail with regard to FIG. 2. While Bluetooth is advantageously used for device relative location, power for a card's Bluetooth circuitry can be obtained by NFC and/or RFID radio waves. Power can be made available for storage on a card from a smartphone when the card is carried relatively closely to the smartphone. Power is also available when a card is read or swiped. Card readers can include NFC or RFID transmitters for activities such as tap-and-pay contactless payment. In countries such as the United States and Japan, RFID readers can generate up to 4 W of effective isotropic radiated power. NFC transmitters may generate up to 750 μW. Wi-Fi rectennas may generate around 150 μW with typical Wi-Fi power levels.

A compact power storage associated with the card can capture and store sufficient power from NFC or RFID waves to keep the card operable over its lifetime. In the example embodiment, electronics and/or power storage may be located in area 128 of card 108.

Area 128 is selected so as to not to contact a card reader during either a chip read during insertion or a magnetic strip read while swiping. Such area is advantageous in embodiments wherein Bluetooth circuitry is added to a card via application of a sticker.

FIG. 2 illustrates an example embodiment 200 of a Bluetooth proximity detection system 200, suitably provided on a sticker 204 comprised of plan view 204a and side view 204b. Sticker 204 includes one or more loop antennas such as loop antenna 208 illustrated as 208a and 208b. A wireless charging coil 212 may be included for conventional charging, such, such as with wireless charger 214. In an example embodiment, wireless charger 214 employs the Qi charging standard developed by the Wireless Power Consortium. Loop antennae are suitably tuned to capture energy from NFC and/or RFID readers. Power is suitably stored in a power cell, suitably formed as a rechargeable battery, an example of which is comprised of one or more capacitive plates such as parallel plates 216 and 220, which plates are separated by dielectric 224.

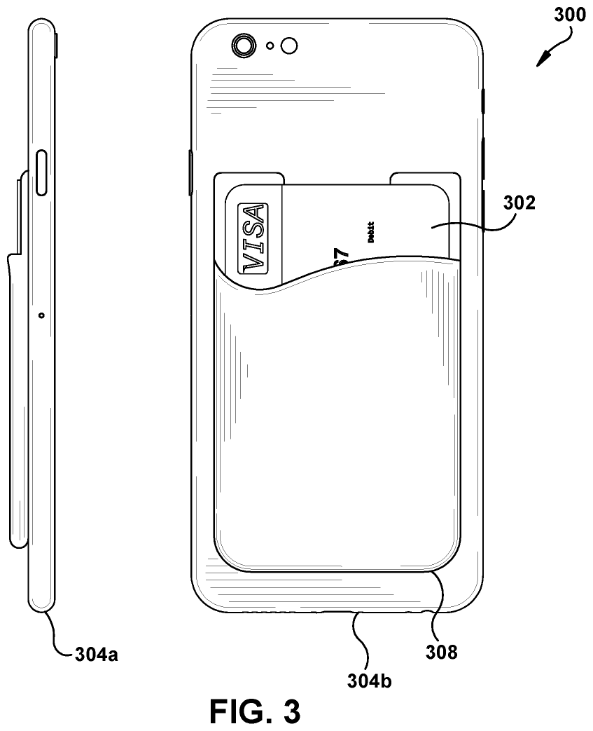

FIG. 3 illustrates a system 300 for maintaining a credit card 302 in close proximity to smartphone 304, illustrated with side view 304a and back view 304b. This is accomplished via an insert sleeve 308 affixed to the back of smartphone 304. With such proximity, power can be continuously received via NFC and/or RFID waves emanating from smartphone 304.

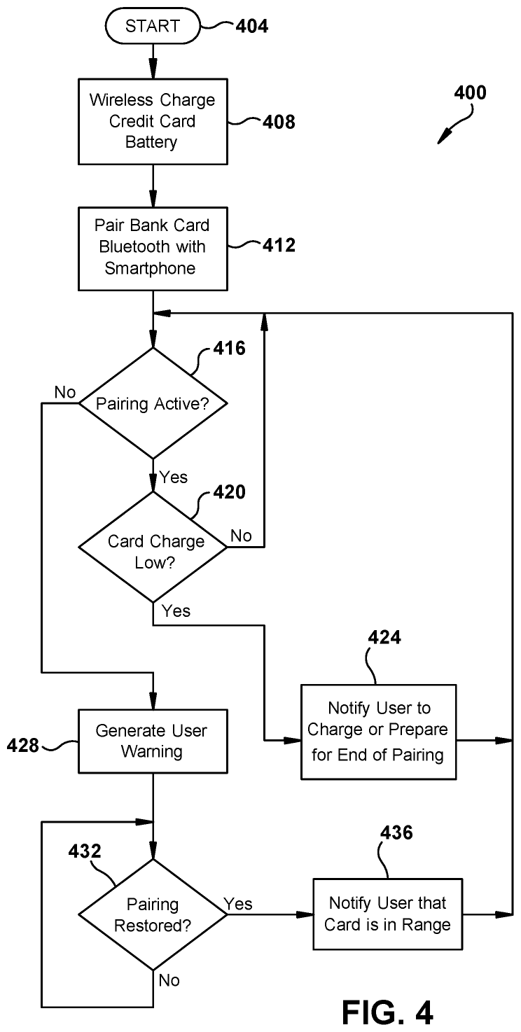

FIG. 4 is a flowchart 400 of example embodiment of an application running on a portable data device, such as a smartphone, that accomplishes monitoring of devices such as bank cards via Bluetooth pairing. The system commences at block 404 and proceeds to block 408 where an initial charge is placed on the bank card. Next, Bluetooth pairing between a smartphone and a bank card is completed at block 412. A determination is made whether Bluetooth pairing is active at block 416. If so, a check is made at block 420 to determine if a card charge is low. This is suitably accomplished via a query made via the established Bluetooth channel, or alternatively by a signal strength associated with the pairing. If the card charge is low, the application notifies the smartphone user at block 424 so as to prepare them for an alarm that may be forthcoming. Such alarm, suitably audible, visible and/or haptic, would be the same alarm generated when a card/smartphone distance threshold has been passed insofar as both conditions result in a loss of pairing. The process then returns to block 416 and another test for active pairing is made.

When pairing is found to be inactive at block 416, a user warning is generated at block 428. A test is made as to whether pairing has been restored at block 432, which restoration may be attributed to the card coming once again in range and/or the card battery having sufficient charge to maintain pairing. If pairing is restored, the user is notified at block 436 and the process returns to block 416.

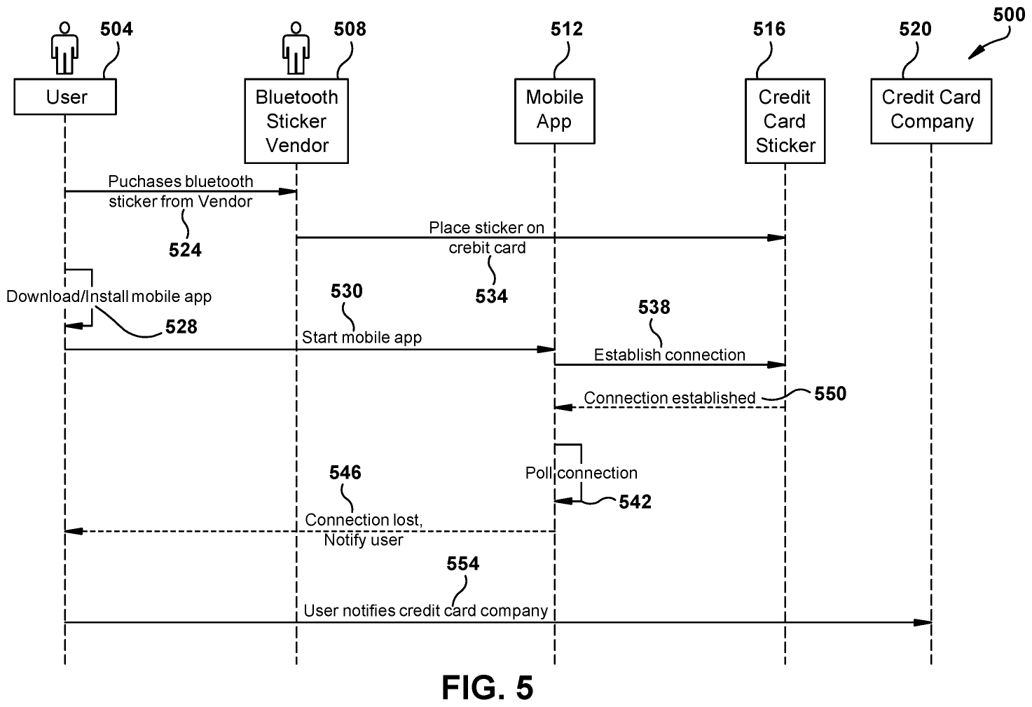

FIG. 5 illustrates constituent interactions 500 associated with distance monitoring via Bluetooth pairing. Such interaction is illustrated among user 504, Bluetooth sticker vendor 508, mobile app 512, credit card sticker 516 and credit card company 520. User 504 activities include purchasing of a Bluetooth sticker from vendor 508 at arrow 524 and downloading and installation of a mobile app at arrow 528 and starting of the app at arrow 530. Bluetooth sticker vendor 508 activities include supplying user 504 with a Bluetooth sticker at arrow 524 and installing the sticker at block 534. The sticker is also suitably applied by user 504.

Mobile app 512 activities, once commenced by user 504 at arrow 530, include establishing a Bluetooth pairing connection with credit card sticker 516 at arrow 538 and arrow 550, polling an established pairing session at block 542 and notifying user 504 of a lost connection and arrow 546. Credit card sticker activity includes establishing a Bluetooth paring connection with mobile app 512 at arrow 538 and arrow 550.

Additional activities include user directed notification of credit card company 520 at arrow 554 in the event that a card is lost or stolen. Such notification is also suitably initiated by mobile app 512 responsive to a response to a generated user prompt requesting whether notification should be made after an alarm has been generated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A portable data device comprising:
a processor and associated memory;
a user interface; and
a data interface including a Bluetooth interface,
wherein the processor is configured to complete a Bluetooth pairing with a Bluetooth interface on an associated financial card, and
wherein the processor is further configured to generate a warning on the user interface when pairing with the financial card is interrupted.

2. The portable data device of claim 1 wherein the processor is further configured to generate a notification on the user interface when pairing is reestablished with the financial card.

3. The portable data device of claim 2 wherein the processor is further configured to poll the Bluetooth interface periodically to determine a state of the pairing.

4. The portable data device of claim 1 further comprising an antenna configured to generate radio frequency waves, comprised of one or more of Wi-Fi, NFC or RFID signals, to the financial card.

5. The portable data device of claim 4 further comprising a card holder secured to a surface thereof, the card holder configured to removably secure the financial card to be adjacent to the surface.

6. The portable data device of claim 1 wherein the processor is further configured to:
generate a query as to whether the financial card has been lost or stolen on the user interface contemporaneously with the generated warning,
receive user input via the user interface responsive to the generated query, and
selectively notify an associated card agency via the data interface that the financial card has been lost or stolen in accordance with received user input.

7. The portable data device of claim 1 wherein the generated warning includes an audible or haptic alarm.

8. A method comprising:
completing a Bluetooth pairing with a Bluetooth interface on a portable data device and a Bluetooth interface on an associated financial card; and
generating a warning on a user interface of the portable data device when pairing with the financial card is interrupted.

9. The method of claim 8 further comprising generating a notification on the user interface when pairing is reestablished with the financial card.

10. The method of claim 9 further comprising polling the Bluetooth interface periodically to determine a state of the pairing.

11. The method of claim 8 further comprising generating radio frequency waves, comprised of one or more of Wi-Fi, NFC or RFID signals, to the financial card.

12. The method of claim 11 further comprising removably securing the financial card to a surface of the portable data device proximate to a near-field interface via a card holder.

13. The method of claim 8 further comprising:
generating a query as to whether the financial card has been lost or stolen on the user interface contemporaneously with the generated warning;
receiving user input via the user interface responsive to the generated query; and
selectively notifying an associated card agency via a data interface of the portable data device that the financial card has been lost or stolen in accordance with received user input.

14. The portable data device of claim 8 further comprising generating the warning as an audible or haptic alarm.

15. A financial card comprising:
a receiver configured to receive radio waves;
a power storage configured to be charged from received radio waves; and
a Bluetooth interface powered by the power storage, the Bluetooth interface configured to pair with an associated, portable data device.

16. The financial card of claim 15 wherein the receiver is comprised of at least one antenna configured to receive radio waves comprising one or more of an RFID signal, a Wi-Fi signal and an NFC signal.

17. The financial card of claim 16 wherein the power storage includes at least two conductive surfaces separated by a dielectric.

18. The financial card of claim 16 wherein the radio waves are at a frequency of 13.56 MHz.

19. The financial card of claim 15 wherein the receiver is comprised of a Qi charging coil.

20. The financial card of claim 16 wherein the receiver, power storage, and Bluetooth interface comprise a sticker secured to the financial card.
